(19) United States
(12) Patent Application Publication
(10) Pub. No.: US 2010/0061502 A1
(43) Pub. Date: Mar. 11, 2010

(54) RACK FOR SPENT NUCLEAR FUEL ASSEMBLIES

(75) Inventors: Hiroto YAMASAKI, Hitachi (JP); Shinji ISAKA, Hitachinaka (JP); Shigeyoshi IWAKURA, Mito (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi-GE Nuclear Energy, Ltd.

(21) Appl. No.: 12/542,152

(22) Filed: Aug. 17, 2009

(30) Foreign Application Priority Data
Sep. 8, 2008 (JP) 2008-229285

(51) Int. Cl. G21C 19/00

(52) U.S. Cl. 376/272

(57) ABSTRACT

Disclosed is a spent fuel storage rack that exhibits high structural strength without unduly increasing the number of welds. The spent fuel storage rack having a plurality of storage cells for storing spent fuel assemblies includes a base plate, a plurality of partition plates having vertically-oriented comb-like slits formed at upper and lower parts thereof or at either the upper or lower part, the partition plates being stacked in multiple levels above the base plate, and a plurality of side plates which surround the peripheries of the plurality of partition plates stacked in multiple levels. The plurality of partition plates are adapted to form the plurality of storage cells in such a manner that a set of the partition plates is repeatedly stacked in the vertical direction while the upper slits formed in the partition plates at a relatively low position is engaged with the lower slits formed in the partition plates at a relatively high position. The plurality of partition plates stacked in multiple levels are coupled to the plurality of side plates by fitting protrusions of both horizontal ends of the plurality of partition plates into slots formed in the plurality of side plates.

### BACKGROUND OF THE INVENTION

1. Field of the Invention

The present invention relates to a rack for spent nuclear fuel assemblies used in fuel facilities at a nuclear power station.

2. Description of the Related Art

A spent fuel storage rack is installed in a spent fuel storage pool within a nuclear power station. Storage cells included in the spent fuel storage rack and arranged in a grid pattern, store spent fuel assemblies removed from a nuclear reactor. The spent fuel storage rack is generally structured by welding component parts securely to assure seismic adequacy. Further, the spent fuel storage rack is designed in consideration of the neutron absorption characteristics of storage cell materials and the shielding effect of water to maintain subcriticality of fuel assemblies under all possible conditions.

In recent years, the density of the spent fuel storage rack has been raised to make effective use of a fuel storage space and provide an increased storage capacity. As a concrete example, the storage capacity has been increased by manufacturing a spent fuel storage rack by using borated stainless steel as a storage cell component material.

A spent fuel storage rack disclosed, for instance, in JP-2001-183491-A is assembled without welding two partition plates that compose a storage cell. More specifically, this spent fuel storage rack is assembled by providing the two partition plates with vertical slits, which are arranged like a comb and spaced at regular intervals, and then engaging the slits with each other.

### SUMMARY OF THE INVENTION

However, the above-mentioned partition plates do not contribute toward an increase in overall rack strength because they are not coupled to or combined with side plates that surround the peripheries of the partition plates. Therefore, the above spent fuel storage rack provides structural strength by using the side plates only. Consequently, there may be a problem with the structural strength of the above spent fuel storage rack.

Particularly, if a spent fuel storage rack including partition plates made of borated stainless steel is to be manufactured in compliance with the ASME standard, the partition plates and side plates cannot be welded together to obtain increased strength because the ASME standard does not allow metals to be welded to borated stainless steel.

Even if the ASME standard is not complied with, welding the partition plates and side plates requires an additional length of time during which welds are inspected for soundness. Further, as thermal deformation occurs due to welding, it is difficult to maintain assembly accuracy. In addition, residual stress may also occur due to welding heat. Especially, welding of borated stainless steel entails arduous management, makes it necessary to perform a complicated manufacturing procedure, imposes an increased burden on workers, and incurs a manufacturing cost increase.

An object of the present invention is to provide a spent fuel storage rack that exhibits high structural strength without unduly increasing the number of welds.

In accomplishing the above object, according to a first aspect of the present invention, there is provided a spent fuel storage rack having a plurality of storage cells arranged in a grid pattern, the storage cells storing spent fuel assemblies therein, the spent fuel storage rack comprising: a base plate; a plurality of partition plates having vertically-oriented comb-like slits formed at upper and lower parts thereof or at either the upper or lower part, the partition plates being stacked in multiple levels above the base plate; and a plurality of side plates which surround the peripheries of the plurality of partition plates stacked in multiple levels, wherein the plurality of partition plates are adapted to form the plurality of storage cells in such a manner that a set of the partition plates is repeatedly stacked in the vertical direction while the upper slits formed in the partition plates at a relatively low position is engaged with the lower slits formed in the partition plates at a relatively high position, and wherein the plurality of partition plates stacked in multiple levels are coupled to the plurality of side plates by fitting protrusions of both horizontal ends of the plurality of partition plates into slots formed in the plurality of side plates.

According to a second aspect of the present invention, there is provided the spent fuel storage rack as described in the first aspect, wherein the plurality of side plates are divided into multiple sets in the vertical direction to conform to each of the multiple levels defined by the plurality of partition plates; and wherein the side plate of each set of the divided side plates is welded to the corresponding side plate adjacent to each other in each set.

According to a third aspect of the present invention, there is provided the spent fuel storage rack as described in the second aspect, wherein the lowest ones of the plurality of partition plates stacked in multiple levels are disposed on the base plate by placing the lowest ones of the vertically divided side plates in face-to-face relation on the base plate and then fitting the protrusions of the partition plates into the slots in the opposing side plates.

According to a fourth aspect of the present invention, there is provided the spent fuel storage rack as described in any one of the first to third aspects, wherein the lowest ones of the plurality of partition plates stacked in multiple levels are fitted in horizontal grooves formed in the base plate.

According to a fifth aspect of the present invention, there is provided the spent fuel storage rack as described in the fourth aspect, wherein the width of the grooves is equal to the thickness of the partition plates.

According to a sixth aspect of the present invention, there is provided the spent fuel storage rack as described in any one of the first to fifth aspects, wherein the base plate and the lowermost parts of the side plates are welded together.

According to a seventh aspect of the present invention, there is provided the spent fuel storage rack as described in any one of the first to fifth aspects, comprising a rack top provided above the plurality of partition plates stacked in multiple levels, the rack top being adapted to serve as an insertion opening when spent fuel assemblies are to be inserted into the storage cells, wherein the plurality of side plates are welded to the base plate and to upper side plates, the upper side plates forming lateral surfaces of the rack top.

According to an eighth aspect of the present invention, there is provided the spent fuel storage rack as described in any one of the first to seventh aspects, wherein the plurality of partition plates are made of borated stainless steel.

According to a ninth aspect of the present invention, there is provided the spent fuel storage rack as described in any one of the first to eighth aspects, wherein the side plate has spacers used for maintaining an adequate distance from a neighboring spent fuel storage rack.

The present invention makes it possible to increase the structural strength of a spent fuel storage rack without increasing the number of welds because it can join the partition plates and side plates without welding them.

### BRIEF DESCRIPTION OF THE DRAWINGS

FIG. 1 is an overall view of a spent fuel storage rack according to a first embodiment of the present invention.

FIG. 2 is a partial structure view illustrating how partition plates engage with each other in the spent fuel storage rack according to the first embodiment of the present invention.

FIG. 3 is an overall view of a spent fuel storage rack according to a second embodiment of the present invention.

FIG. 4 is a diagram illustrating a step of engaging second-level partition plates with first-level partition plates and side plates in the spent fuel storage rack according to the second embodiment of the present invention.

FIG. 5 is a diagram illustrating a state where the second-level partition plates are engaged with the first-level partition plates by performing the step illustrated in FIG. 4.

FIG. 6 is a diagram illustrating an alternative procedure for assembling the first-level partition plates and side plates in the spent fuel storage rack according to the second embodiment of the present invention.

### DESCRIPTION OF THE PREFERRED EMBODIMENTS

Embodiments of the present invention will now be described with reference to the accompanying drawings.

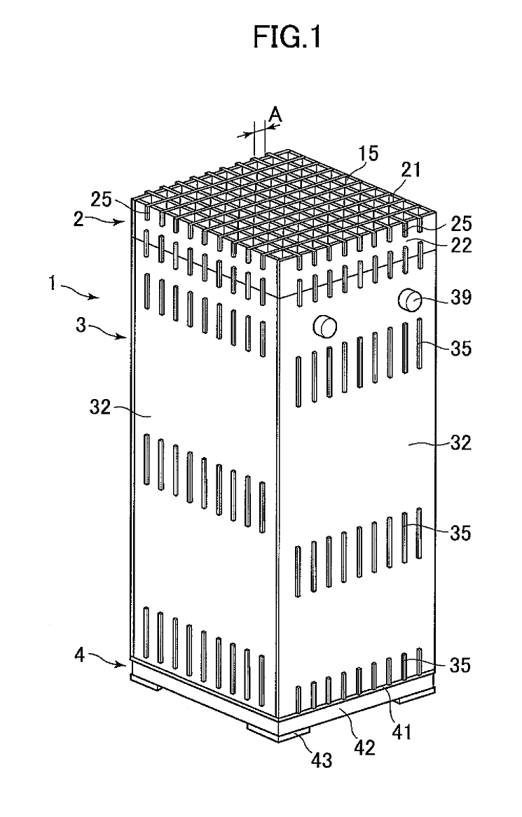

FIG. 1 is an overall view of a spent fuel storage rack according to a first embodiment of the present invention.

The spent fuel storage rack 1 shown in FIG. 1 has a rack top 2, a rack body 3, and a rack base 4, and contains a plurality of storage cells 15 which are arranged in a grid pattern to store spent fuel assemblies.

The rack top 2 serves as an insertion opening when spent fuel assemblies are to be inserted into the storage cells 15 of the rack 1, and is placed at the uppermost part of the rack 1. The rack top 2 has a plurality of upper partition plates 21 and four upper side plates 22. The four upper side plates 22 surround the peripheries of the upper partition plates 21.

The upper partition plates 21 are disposed orthogonally in longitudinal and transverse directions and spaced at regular intervals A (see FIG. 1) to form the plurality of storage cells 15. There are protrusions (not shown) on both horizontal ends of each upper partition plate 21. The protrusions fit into slots 25 (described later) in the upper side plates 22. In the present embodiment, the upper partition plates 21 are made of stainless steel and welded together at the point of intersection.

The upper side plates 22 are four members that surround the peripheries of the upper partition plates 21 which form the plurality of storage cells 15 as described above. These four upper side plates 22 form lateral surfaces of the outermost storage cells 15. The upper side plates 22 have the slots 25 into which the protrusions of the upper partition plates 21 fit, and are coupled to the upper partition plates 21 through the slots 25. In the present embodiment, the upper side plates 22 are made of stainless steel as is the case with the upper partition plates 21, and welded to the neighboring upper side plates 22 and to side plates 32 (described later) of the rack body 3. When the rack top 2 (that is, the upper partition plates 21 and upper side plates 22) is made of stainless steel and welded to the side plates 32 (described later) of the rack body 3 as described in connection with the present embodiment, the structural strength of the rack 1 is increased.

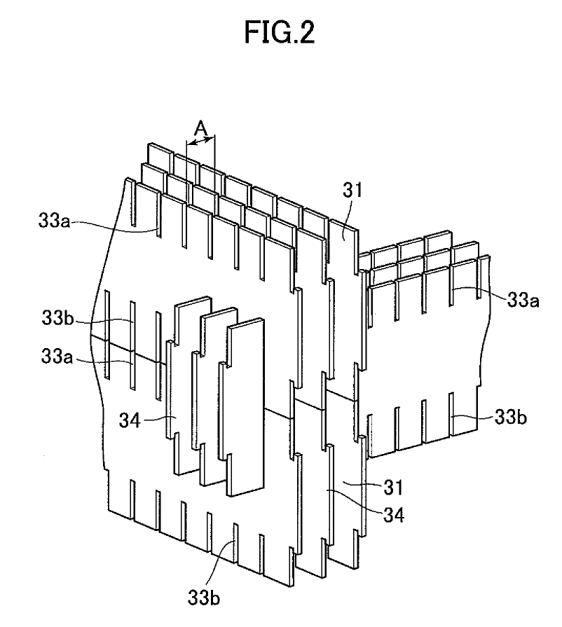

The rack body 3 is positioned beneath the rack top 2 to form a main body of the rack 1. The rack body 3 includes four side pates 32 and a plurality of partition plates 31 (see FIG. 2). The partition plates 31 are stacked in multiple levels inside the side plates 32.

The side plates 32 are members that surround the peripheries of the plurality of partition plates 31 which are stacked in multiple levels, and serve as main components for providing the structural strength of the rack 1. To provide increased structural strength of the rack 1, it is preferred that the side plates 32 be made of stainless steel and welded to the upper side plates 22 of the rack top 2. Further, the side plates 32 are provided with a plurality of slots 35 which are aligned with protrusions 34 (described later) of the partition plates 31. Each of the side plates 32 according to the present embodiment is composed of a single plate member extended in a vertical direction (in the direction of the height of the rack 1) between the rack base 4 and rack top 2. In other words, the side plates 32 according to the present embodiment are four members that form the lateral surfaces of the rack body 3.

In addition, the side plates 32 prevent criticality which may be caused by the reciprocal influence between spent fuel assemblies in the outermost storage cells 15 of one rack 1 and spent fuel assemblies in the outermost storage cells 15 of a neighboring rack 1. Subcriticality of fuel assemblies can be assured by two thicknesses of side plates 32 of adjacent racks and by water between the adjacent racks in the spent fuel storage pool (that is, the distance between two racks). In the present embodiment, the outer surfaces of the side plates 32 are equipped with spacers 39 that are dimensioned to obtain a necessary amount of inter-rack water for subcriticality assurance by maintaining an adequate distance between the side plates 32 of adjacent racks. When the spacers 39 are installed as described above, subcriticality can always be assured.

The partition plates 31 are used to form individual storage cells 15 and prevent the spent fuel assemblies in adjacent storage cells 15 from affecting each other and reaching criticality. It is therefore preferred that the partition plates 31 be made of borated stainless steel or other material having a high neutron absorption capability. The partition plates 31 will now be described in detail with reference to FIG. 2.

FIG. 2 is a partial structure view illustrating how the partition plates 31 engage with each other in the spent fuel storage rack according to the present embodiment. Some partition plates 31 are excluded from this figure to make it easy to understand the relationship between individual partition plates 31.

Referring to FIG. 2, the partition plates 31 have vertically-oriented comb-like slits 33 at upper and lower parts or at either the upper or lower part, and are stacked in multiple levels on a base plate 41 (described later) of the rack base 4. The slits 33 are divisible into upper slits 33a positioned at an upper part of each partition plate 31, and lower slits 33b positioned at a lower part of each partition plate 31.

The individual partition plates 31 are repeatedly stacked in a vertical direction to form the plurality of storage cells 15 by engaging the upper slits 33a in the partition plates 31 at a relatively lower position with the lower slits 33b in the partition plates 31 at a relatively higher position. The partition plates 31 at each level are disposed unidirectionally in the same plane and spaced at regular intervals A. Vertically adjacent partition plates 31 are oriented orthogonally to each other. The lower slits 33b in a partition plate 31 at a relatively higher level orthogonally engages with the upper slits 33a of a partition plate 31 at a relatively lower level.

Further, each partition plate 31 has protrusions 34 which protrude from both horizontal ends toward the side plates 32. The protrusions 34 fit into the slots 35 in the side plates 32. When the partition plates 31 are coupled to the side plates 32 in the above manner via the protrusions 34 and slots 35, force transmission can take place between the partition plates 31 and side plates 32. Therefore, the partition plates 31 can contribute to the structural strength of the spent fuel storage rack 1. Consequently, the structural strength of the spent fuel storage rack 1 can be increased without welding or otherwise joining the partition plates 31 and side plates 32. All the partition plates 31 need not always be equipped with the protrusions 34 depending on the height of the partition plates 31. Alternatively, the partition plates 31 having the protrusions 34 may be stacked at intervals appropriate for assuring the structural strength of the spent fuel storage rack 1.

The rack base 4 supports the rack top 2 and rack body 3 and is positioned at the lowermost part of the spent fuel storage rack 1. The rack base 4 includes a base plate 41 in which the lowermost parts of the lowest partition plates 31 and of the side plates 32 are fitted, a base 42 on which the base plate 41 is mounted, and legs 43 which are attached to four corners of the bottom surface of the base 42. For increased structural strength of the spent fuel storage rack 1, it is preferred that the base plate 41 be welded or otherwise securely joined to the side plates 32 and made of stainless steel.

As the spent fuel storage rack 1 is configured as described above, the side plates 32 which serve as main components for providing the structural strength of the spent fuel storage rack 1, can be joined to the partition plates 31 without resorting to welding, or more specifically, by fitting the protrusions 34 into the slots 35. Thus, the structural strength of the spent fuel storage rack 1 can be enhanced without increasing the number of welds. Consequently, the side plates 32 and partition plates 31 assure that the spent fuel storage rack 1 has sufficient structural strength against possible earthquakes.

When, in the above-described spent fuel storage rack 1, the upper side plates 22 and base plate 41 are welded to the side plates 32, the rack top 2, base plate 41, and side plates 32 apply upward force, downward force, and lateral force to securely fix the partition plates 31 in the rack 1. This eliminates the necessity of welding the partition plates 31 whose slits 33 are engaged with each other, thereby decreasing the number of welding operations and the time required for rack manufacture and inspection. As a result, the cost of rack manufacture can be reduced. Further, since this eliminates the necessity of resorting to welding even when the partition plates 31 are made of borated stainless steel, it is possible to manufacture the rack 1 that complies with the ASME standard and exhibits high structural strength. In addition, it is possible to minimize the number of components that functionally requires the use of borated stainless steel which is more expensive than stainless steel. Therefore, the cost of materials can also be reduced.

Further, when the partition plates 31 are stacked in multiple levels to form the storage cells 15 and divide them in a vertical direction within the rack body as described in connection with the present embodiment, it is possible to manufacture component parts with increased ease and provide increased handling ease during assembly as compared to a case where the storage cells 15 are manufactured without dividing them in a vertical direction. Furthermore, as the partition plates 31 stacked earlier at the time of assembly are positionally locked by their lower slits 33b, their upper slits 33a serve as a positioning reference for the partition plates 31 to be stacked later. It is therefore possible to sequentially stack higher partition plates 31 at appropriate positions without having to make special positional adjustments. This will facilitate assembly work and provide increased assembly accuracy.

Moreover, when the plurality of partition plates 31 are stacked in multiple levels to form the storage cells 15 as described above, the upper and lower ends of the partition plates 31 need not be in close contact with each other as far as subcriticality is assured. Consequently, the machining accuracy requirements for the partition plates 31 can be relaxed as compared to a case where the partition plates are not stacked. This makes it possible to provide improved partition plate manufacturability and rack assemblability.

In addition, when the storage cells 15 are formed with the plurality of partition plates 31 as described above, the partition plates 31 formulating some storage cells 15 may be thicker than the other partition plates 31. This makes it possible to partially increase the structural strength of the rack 1. Therefore, even when it is demanded that the rack 1 exhibit increased structural strength, such a demand can be met in a flexible manner. In such an instance, the partition plates 31 may be made of stainless steel having high structural strength as far as subcriticality is assured.

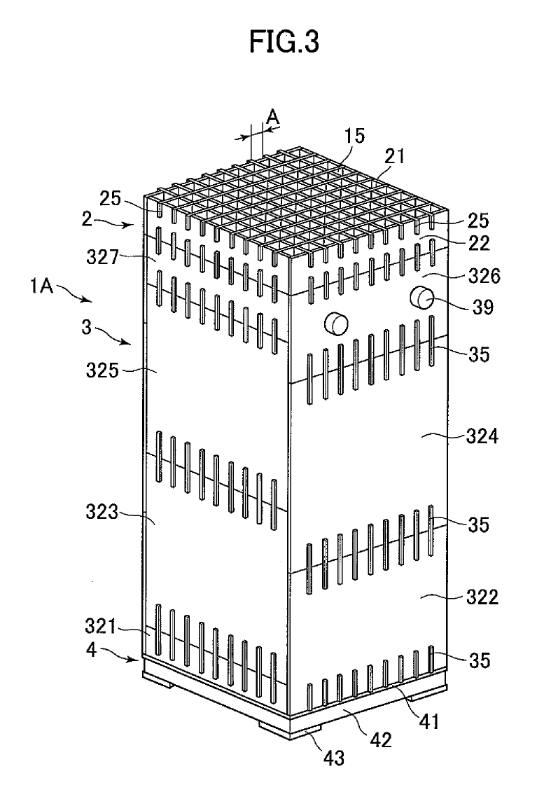

FIG. 3 is an overall view of a spent fuel storage rack according to a second embodiment of the present invention. Like elements in FIGS. 1 to 3 are designated by the same reference numerals and will not be redundantly described (this is also true of the subsequent drawings).

The spent fuel storage rack shown in FIG. 3 differs from the spent fuel storage rack according to the first embodiment in that the former includes divided side plates 32 (side plates 321-327).

The side plates 32 are divided in a vertical direction into multiple sets in accordance with levels formed by a plurality of partition plates 31. The spent fuel storage rack 1A is assembled by repeatedly disposing the plurality of partition plates 31 unidirectionally in a plane to form a level and engaging the side plates 32 corresponding to that level with protrusions 34 of the partition plates 31.

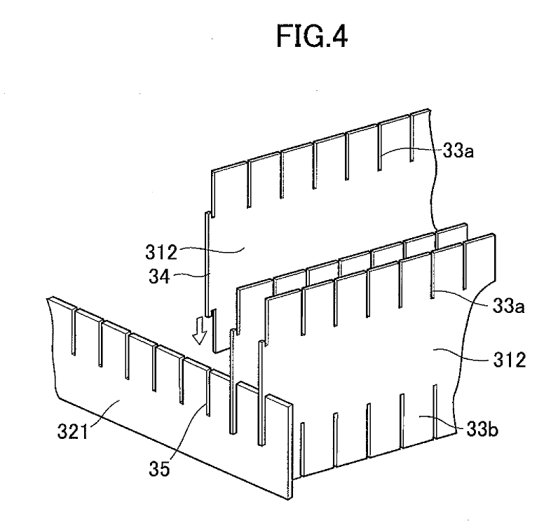

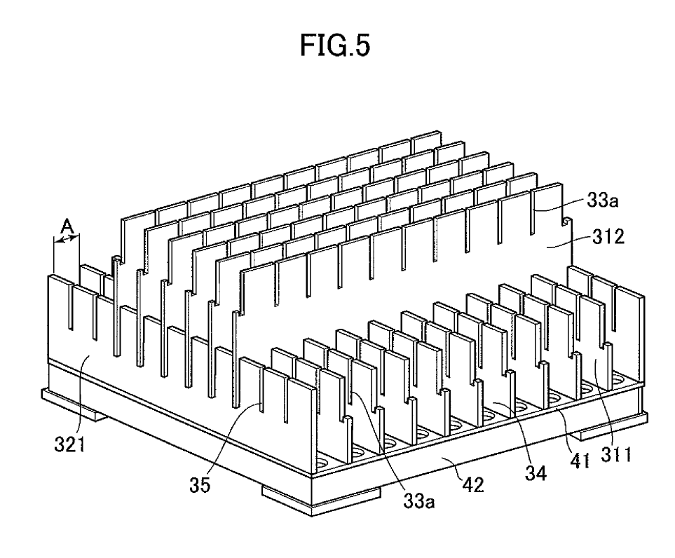

A procedure for assembling the spent fuel storage rack 1A according to the second embodiment will now be described in detail with reference to FIGS. 4 and 5. FIG. 4 is a diagram illustrating a step (step (4) below) of engaging second-level partition plates 312 with first-level partition plates 311 and side plates 321. FIG. 5 is a diagram illustrating a state where the second-level partition plates 312 are engaged with the first-level partition plates 311 by performing the step illustrated in FIG. 4. It should be noted that the first-level partition plates 311 are omitted from FIG. 4.

(1) In preparation for assembly, slits 33 and slots 35, 25 are made in individual materials for the partition plates 31, side plates 32, and upper side plates 22. In the present embodiment, the slits 33 or slots 35 are made only in the upper part of the first-level partition plates 311 and side plates 321, and in both the upper and lower parts of the second- and higher-level partition plates 311 and side plates 321.

(2) The base plate 41 and the base 42 are welded or otherwise joined.

(3) The first-level partition plates 311 and the first-level side plates 321 which sandwich the first-level partition plates 311 in-between, are disposed unidirectionally on the base plate 41 and spaced at intervals A for forming the storage cells 15.

(4) The protrusions 34 of the second-level partition plates 312 are fitted into the slots 35 in the first-level side plates 321 while the lower slits 33b in the second-level partition plates 312 are engaged with the upper slits 33a in the first-level partition plates 311 (see FIGS. 4 and 5).

(5) The second-level side plates 322 are disposed in such a manner that the protrusions 34 of the first-level partition plates 311 fit into the slots 35 in the second-level side plates 322 (see FIG. 3).

(6) Steps (4) and (5) above are repeated to stack the third- and higher-level partition plates 31 and side plates 32. As shown in FIG. 3, the present embodiment uses the first- to seventh-level side plates 32 (the seventh-level side plates are designated by the reference numeral 327).

(7) The protrusions of the upper partition plates 21 for the rack top 2 are fitted into the upper-end slots 35 in the side plates 326, 327 while the slits (not shown) in the upper partition plates 21 for the rack top 2 are engaged with the upper slits 33a in the uppermost partition plates 31 (not shown).

(8) Adjacent portions of the side plates 321 to 327 are welded together. When the above steps are completed, the resulting rack looks like FIG. 3.

Advantages provided by the present embodiment will now be described in comparison with those provided by the first embodiment. In the first embodiment, each lateral surface of the rack body 3 is provided with only one side plate 32. Therefore, it is necessary to make slots 35 at positions corresponding to all protrusions 34 of each lateral surface, and manufacture the side plates 32 with high precision. Further, if the partition plates 31 are to be made of borated stainless steel in a situation where a rack having high structural strength is to be manufactured in compliance with the ASME standard, it is necessary to increase the structural strength by accurately fitting the protrusions 34 into the slots 35 because the partition plates 31 and side plates 32 cannot be welded together. Therefore, when the partition plates 31 and side plates 32 cannot be welded together, the accuracies of the protrusions 34 and slots 35 constitute a very serious concern.

On the other hand, the present embodiment is configured so that the side plates 32 are divided in a vertical direction in accordance with the levels formed by the partition plates 31. When the side plates 32 are divided in such a manner, it is merely necessary to align the protrusions 34 with the slots 35 on each level. Therefore, the present embodiment is more likely to attain high accuracy than the first embodiment and makes it easier to engage the side plates 32 with each other. It means that the present embodiment provides higher assemblability of the spent fuel storage rack 1A than the first embodiment. In other words, assembly can be accomplished with high accuracy even when the partition plates 31 and side plates 32 cannot be welded together. This makes it easy to increase the structural strength. Further, dividing the side plates 32 as described above is advantageous because it facilitates the manufacture of component parts and provides increased handling ease during assembly.

When step (3) is performed as described above to assemble the spent fuel storage rack 1A, the base plate 41 may be provided with horizontal grooves (not shown) in which the first-level partition plates 311 and side plates 321 are to be fitted. When such grooves are made in the base plate 41, the accuracy of rack assembly can be increased because the partition plates 31 and side plates 32 can be placed in a horizontal position even if the flatness of the base plate 41 is low. In such an instance, the width of the grooves may be made equal to the thickness of the partition plates 31 or side plates 32. Making such grooves in the base plate 41 further increases the assembly accuracy. It goes without saying that the rack 1 according to the first embodiment may be provided with the above-described horizontal grooves to enhance the assembly accuracy.

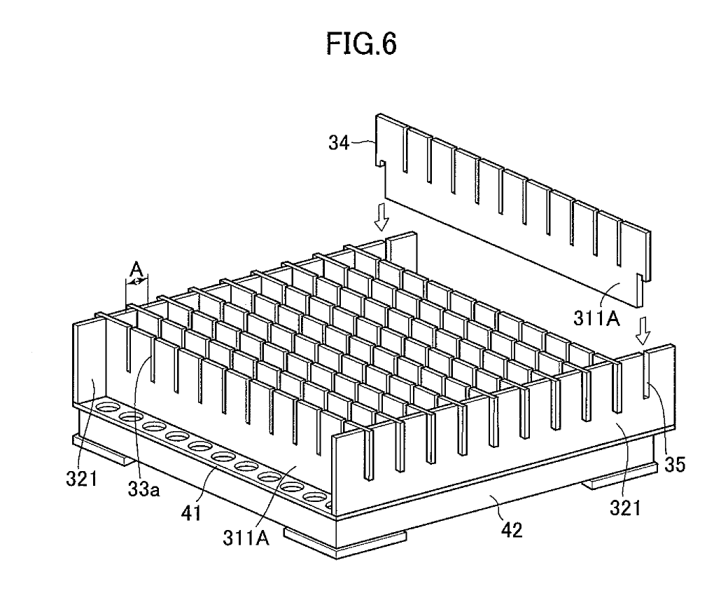

Alternatively, the first-level partition plates 311 and side plates 321 may be mounted on the base plate 41 in a manner described below instead of performing step (3) above. This alternative method will now be described with reference to FIG. 6.

FIG. 6 is a diagram illustrating an alternative procedure for assembling the first-level partition plates 311A and side plates 321 according to the present embodiment.

The first-level partition plates 311A shown in FIG. 6 have upper protrusions 34 in marked contrast to the partition plates 311 (see FIG. 5) that are used in the example described earlier and provided with lower protrusions 34. When the spent fuel storage rack is to be assembled, the first-level side plates 321 are disposed at each end of the base plate 41 in an opposing manner, and then the first-level partition plates 311A are disposed on the base plate 41 while fitting their protrusions 34 into the slots 35 in the two opposing side plates 321.

When the employed structure is such that the protrusions 34 of the partition plates 311A are to be fitted into the slots 35 in the two preinstalled side plates 321 as described above, the first-level partition plates 311A can be disposed in appropriate positions without making any special positional adjustments. As this eliminates the necessity of performing a fabrication or other operation for positioning the first-level partition plates 311A, the assemblability of the rack is further improved.

What is claimed is:

1. A spent fuel storage rack having a plurality of storage cells arranged in a grid pattern, the storage cells storing spent fuel assemblies therein, the spent fuel storage rack comprising:
a base plate;
a plurality of partition plates having vertically-oriented comb-like slits formed at upper and lower parts thereof or at either the upper or lower part, the partition plates being stacked in multiple levels above the base plate; and
a plurality of side plates which surround the peripheries of the plurality of partition plates stacked in multiple levels;
wherein the plurality of partition plates are adapted to form the plurality of storage cells in such a manner that a set of the partition plates is repeatedly stacked in the vertical direction while the upper slits formed in the partition plates at a relatively low position is engaged with the lower slits formed in the partition plates at a relatively high position; and
wherein the plurality of partition plates stacked in multiple levels are coupled to the plurality of side plates by fitting protrusions of both horizontal ends of the plurality of partition plates into slots formed in the plurality of side plates.

2. The spent fuel storage rack according to claim 1, wherein the plurality of side plates are divided into multiple sets in the vertical direction to conform to each of the multiple levels defined by the plurality of partition plates; and wherein the side plate of each set of the divided side plates is welded to the corresponding side plate adjacent to each other in each set.

3. The spent fuel storage rack according to claim 2, wherein the lowest ones of the plurality of partition plates stacked in multiple levels are disposed on the base plate by placing the lowest ones of the vertically divided side plates in face-to-face relation on the base plate and then fitting the protrusions of the partition plates into the slots in the opposing side plates.

4. The spent fuel storage rack according to any one of claims 1 to 3, wherein the lowest ones of the plurality of partition plates stacked in multiple levels are fitted in horizontal grooves formed in the base plate.

5. The spent fuel storage rack according to claim 4, wherein the width of the grooves is equal to the thickness of the partition plates.

6. The spent fuel storage rack according to any one of claims 1 to 3, wherein the base plate and the lowermost parts of the side plates are welded together.

7. The spent fuel storage rack according to any one of claims 1 to 3, comprising a rack top provided above the plurality of partition plates stacked in multiple levels, the rack top being adapted to serve as an insertion opening when spent fuel assemblies are to be inserted into the storage cells, wherein the plurality of side plates are welded to the base plate and to upper side plates, the upper side plates forming lateral surfaces of the rack top.

8. The spent fuel storage rack according to any one of claims 1 to 3, wherein the plurality of partition plates are made of borated stainless steel.

9. The spent fuel storage rack according to any one of claims 1 to 3, wherein the side plate has spacers used for maintaining an adequate distance from a neighboring spent fuel storage rack.
